(19) United States
(12) Patent Application Publication
(10) Pub. No.: US 2011/0225400 A1
(43) Pub. Date: Sep. 15, 2011

(54) Device for Testing a Multitasking Computation Architecture and Corresponding Test Method

(75) Inventor: Iker De Poy Alonso, Saint Martin d'Heres (FR)

(73) Assignee: STMicroelectronics (Grenoble 2) SAS, Grenoble (FR)

(21) Appl. No.: 13/036,919

(22) Filed: Feb. 28, 2011

(30) Foreign Application Priority Data
Mar. 11, 2010 (FR) 1051761

(51) Int. Cl. G06F 9/30

(52) U.S. Cl. 712/227; 712/E09.032

(57) ABSTRACT

A device and method for testing a multitasking computation architecture is provided. Sequences of test instructions are generated corresponding to programming rules for the computation architecture. The execution of the instruction sequences is controlled so that the sequences are alternately executed within the computation architecture.

### CROSS-REFERENCE TO RELATED APPLICATION

This application claims the priority benefit of French patent application number 1051761, filed Mar. 11, 2010, entitled “Device for testing a multitasking computation architecture and corresponding test method,” which is hereby incorporated by reference to the maximum extent allowable by law.

### TECHNICAL FIELD

The invention relates, generally, to multitasking computation architectures and, in particular, to a device and a method for testing such architectures.

### BACKGROUND

“Multitasking computation architectures” include architectures capable of alternately carrying out a number of instructions. For example, multitasking computation architectures include any type of multitasking architectures, such as the architectures that use the VLIW (very long instruction word) technologies, according to which each word is likely to contain a number of instructions, the architectures generally known as “multi-threading” architectures, according to which a computer is capable of alternately processing a number of instruction threads, the SIMD (single instruction on multiple data) architectures, according to which a computer comprises a number of computation units operating in parallel, the floating-point architectures, and so on.

To test such multitasking computation architectures, it is generally desirable to perform a number of test instructions by using simulation techniques.

First of all, tests are generally carried out on an instruction set simulator (ISS), then on register transfers and then on a summarized final version of the processor as implemented on a programmable logic circuit.

Such tests are intended to identify different failure levels which are likely to occur within the architecture. They are also intended to identify failures within the compiler, in particular regarding the instructions, the syntax, the semantics, etc.

The tests are also capable of covering a maximum, or even all, of the multitasking scenarios that are likely to be implemented within the architecture.

There are already, within the state of the art, computation architecture test devices. The company OBSIDIAN proposes, in this respect, a test tool marketed under the name Raven®. Reference can also be made to the test tool called Genesys®, marketed by the company IBM, which offers a dynamic and configurable test generation tool.

It has, however, been found that the test tools that are currently available can be used only by specialists in multitasking processing architectures, and are long and tedious to use. Furthermore, they are not perfectly suited to the testing of multitasking processing architectures. Finally, they are relatively costly.

There is therefore proposed, according to the present description, a device and method for testing multitasking computation architectures which, according to a general feature, comprise generating sequences of test instructions corresponding to programming rules for the computation architecture, and controlling the execution of the instruction sequences, so that said sequences are alternately executed within the computation architecture.

### SUMMARY

In an embodiment, a device that may be used for testing a multitasking computation architecture is provided. The device includes a sequence generator and a controller. The sequence generator generates sequences of test instructions corresponding to programming rules for the computation architecture, and the controller controls a parallel execution of the sequences of test instructions so that said sequences of test instructions are alternately executed.

In another embodiment, a method that may be used for testing a multitasking computation architecture is provided. The method comprises generating sequences of test instructions corresponding to programming rules for the multitasking computation architecture, and executing the sequences of test instructions so that said sequences of test instructions are alternately executed.

In yet another embodiment, a computer program product for testing a multitasking computation architecture is provided. The computer program product includes computer program code for generating one or more test programs for each of a plurality of threads that may be executed at least in part in parallel to one another, wherein the computer program code for generating includes computer program code for synchronizing the test programs of the plurality of threads. The computer program product also includes computer program code for controlling parallel execution of the test programs.

### BRIEF DESCRIPTION OF THE DRAWINGS

Other aims, features and advantages of embodiments will become apparent from reading the following description, given solely as a nonlimiting example, and with reference to the appended drawings in which:

FIG. 1 illustrates a general architecture of a test device according to an embodiment;

FIG. 2 is a diagram illustrating a mechanism for synchronizing test instructions; and

FIG. 3 illustrates another embodiment of a mechanism for synchronizing test instructions.

### DETAILED DESCRIPTION OF ILLUSTRATIVE EMBODIMENTS

According to an embodiment, a test device may comprise synchronization for controlling the alternate execution of instructions of the test sequences.

In another embodiment, the test device may also comprise storage for storing a representation of the computation architecture to be tested.

For example, the test device comprises storage for storing a description of the programming instructions for the computation architecture.

According to another aspect, there is also proposed a method for testing a multitasking architecture.

According to a general feature, the test method comprises the steps for:

generating sequences of test instructions corresponding to programming rules for the computation architecture; and

executing sequences of test instructions so that said sequences are alternately executed within the computation architecture.

In one embodiment, the parallel execution of the sequences of test instructions is performed in steps between two consecutive synchronization points, up to an output point, each step comprising:

an execution of a first sequence of instructions until a first synchronization point is reached, then

successive execution of consecutive sequences of instructions, each sequence of instructions being executed until said synchronization point is reached for said sequence.

It is possible to provide for the number of synchronization points to be identical for each sequence of test instructions.

The test sequences may be chosen randomly.

There is also proposed, according to another aspect, a multitasking computation architecture comprising a test device as defined hereinabove.

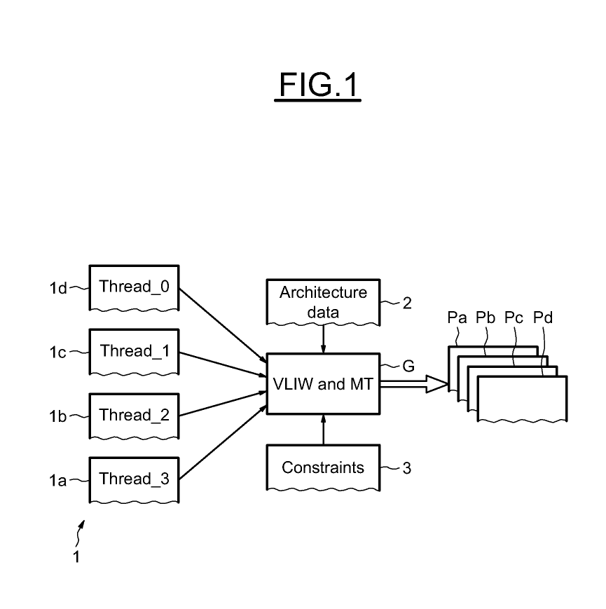

The general architecture of a device for testing a multitasking computation architecture will be described first, with reference to FIG. 1. Such an architecture is also known as a “multi-thread” architecture.

The device generates, randomly, an indeterminate number of test sequences Pa, Pb, . . . Pd modulo n, n being the number of computation threads in a multi-thread architecture. The aim here is to generate a sequence of test instructions for each thread of the multi-thread architecture, the set of these n sequences constituting a multi-thread test. In other words, the aim is therefore to create a set of test sequences for testing all of the tasks executed by a multitasking architecture.

Such a device enables the user, for example a circuit designer, a quality controller, etc., to proceed with tests that are directly selected, or, on the other hand, randomly selected. However, the tests implemented are founded on the execution of test programs generated according to the programming rules for the computation architecture and according to the architecture of the computer to be checked.

When a user carries out a non-random test, the user selects the type and the format of the instructions and the operand value of the test sequences. On the other hand, when the tests are carried out randomly, these values are chosen randomly by the test device.

As FIG. 1 shows, the device mainly comprises a sequence generator 1 for generating sequences of test instructions.

The sequence generator 1 comprises storage 1a, 1b, 1c and 1d for test sequences Thread_0, . . . , Thread_3 each corresponding to test scenarios, and may be implemented as text files that use parameterizable macroprograms. Each scenario makes it possible to provide a large number of tests generated randomly with respect to scenario constraints.

The device also includes architecture data 2 for storing a representation of the computation architecture to be tested, and for storing parameters descriptive of the programming instructions for the computation architecture to be tested. The device further includes a test program generator G used to generate the test programs according to the programming rules for the architecture to be checked.

Thus, based on the test scenarios from the sequence generator 1, and according to the description of the programming instructions for the architecture to be tested, a set of test sequences proper is generated by automatically selecting operation codes (Op-codes) and operands for the test instructions. This selection is, however, made under the control of constraints 3, which may be stored in a memory. These constraints 3 correspond to directives that are likely to influence all the possible values for the operation codes and for the operands that the test device is likely to generate. It will be noted that the higher these constraints, the more selective the tests.

Thus, the test generator G constructs the set of program files Pa, Pb, Pc and Pd from the test scenarios 1a, 1b, 1c and 1d based on the description of the architecture to be tested and on the instructions set of this architecture, stored in the architecture data 2, and according to the constraints 3.

These programming files Pa, Pb, Pc and Pd each correspond to a sequence of test instructions programmed, for example, in a low-level language and able to be executed within the architecture.

It will, however, be noted that, as mentioned previously, the computation architecture to be tested may be a multitasking architecture, able to perform a set of tasks which may, often, share one and the same memory.

Thus, in order to be able to use previously loaded memory addresses to implement a first test file, for the execution of other test files, the device performs, in parallel and alternately, the sequences of test instructions and also implements a synchronization mechanism defining intermediate breakpoints for the test sequences.

This synchronization mechanism is, for example, executed within the test generator G which incorporates means for controlling the execution of the test instructions making it possible to implement this synchronization.

These waiting points are used to stop the execution of a test sequence in order to wait for the other test sequences to have been performed for the other computation threads of the multitasking computation architecture.

It will be noted that the number of waiting points is identical for all the computation threads. Furthermore, between two consecutive synchronization points, no interaction between the memory areas of different computation threads is provided.

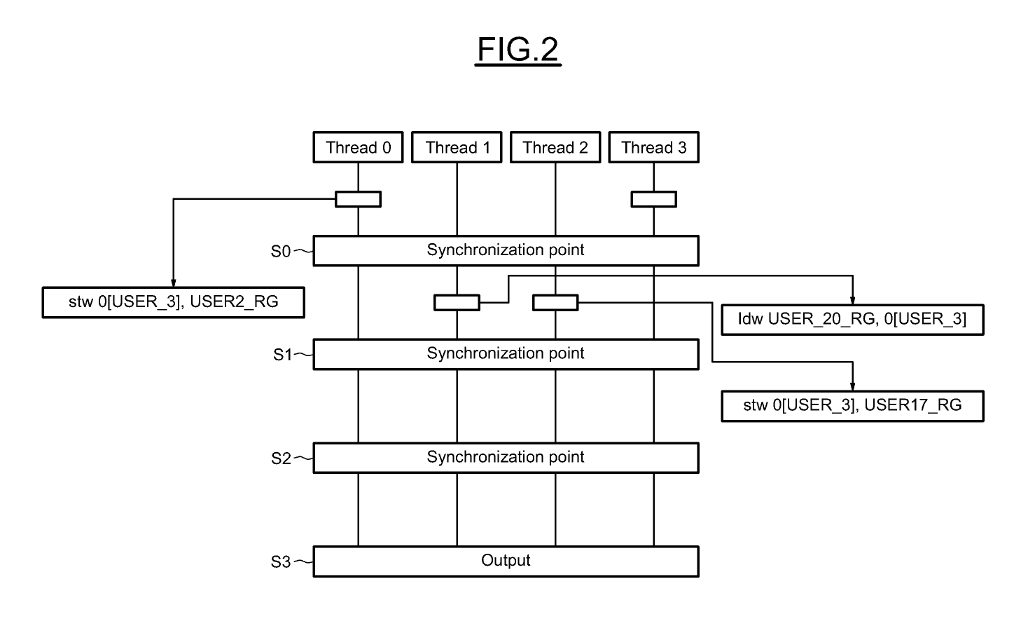

Reference should be made to FIG. 2, which illustrates four computation threads Thread_0, Thread_1, Thread_2 and Thread_3 of a multitasking architecture.

In order to test this architecture, sequences of instructions may be generated for each thread, with constraints linked to the use of the resources shared by these threads, and with the determination of synchronization points. For example, the shared resources may relate to a memory shared between the computation threads but, such resources may be extended to other elements, such as memory-based functional block registers.

Testing the architecture also involves executing the sequences between the common synchronization points.

It will be noted that the generation of the sequences of instructions is done so that, if a sequence of instructions assigned to a thread uses a resource shared with the other sequences of instructions assigned to the other threads, this resource becomes the exclusive property of this sequence of instructions until all the sequences of instructions for each thread reach a common synchronization point.

In the example of FIG. 2, the sequence of instructions assigned to the first thread Thread_0 uses read-mode memory addresses. Thus, the sequences of instructions generated for the other threads should not use the same memory addresses.

Such is in particular the case for the last thread Thread_3 which makes read-mode and/or write-mode reference to the address used by the sequence of instructions for the first thread Thread_0. The generators take into account this constraint by preventing any reference to memory areas used by each of the other threads.

It will be noted that the synchronization points are defined by the instruction sequence generator. When the sequences of instructions have all reached a synchronization point, the private resources of each of the sequences are released and become available for use for each of the sequences of instructions assigned to the threads by observing the same constraints defined previously.

Thus, in the example illustrated in FIG. 2, after the first synchronization point S0 has been crossed, the sequences of instructions assigned to the second and third threads Thread_1 and Thread_2 may once again use, both in read and write modes, the resources assigned to the sequence of instructions for the first thread Thread_0 before the first synchronization point S0 has been crossed. However, if the sequence of instructions for the second thread Thread_1 uses this resource in write mode, then it will become its exclusive property and should not be used for any sequence of instructions assigned to the other threads Thread_0, Thread_2 and Thread_3.

If, in the other case, the sequence of instructions for the second thread Thread_1 uses this resource in read mode, then it will continue to remain available in read mode for the other sequences of instructions assigned to the other threads Thread_0, Thread_2 and Thread_3.

Thus, a sequence of instructions becomes the exclusive property of a shared resource if it performs a write operation.

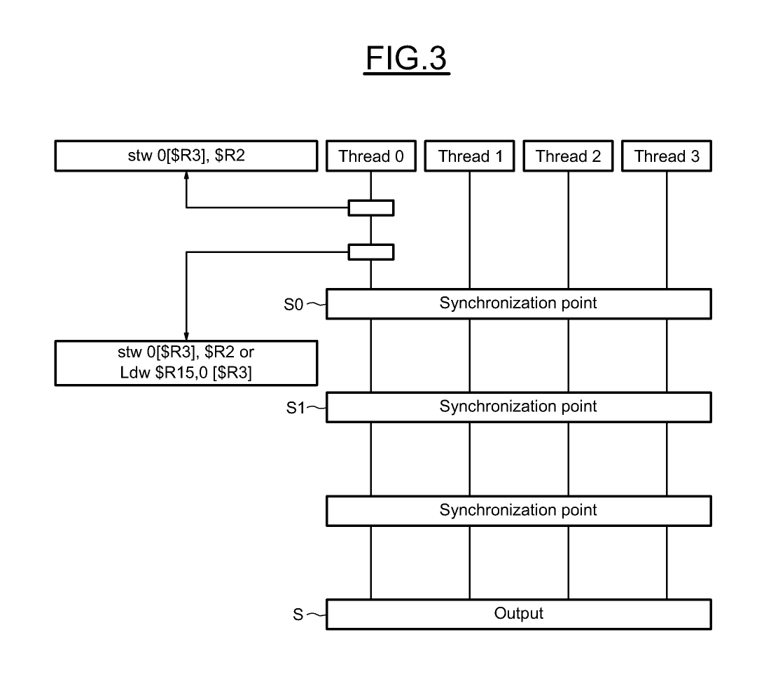

This constraint is illustrated in FIG. 3, which shows that, when the shared memory resources are used in write mode by the instructions assigned to the first thread Thread_0, these resources cannot be used by the other computation threads Thread_1, Thread_2 and Thread_3.

In the case where a sequence of instructions is assigned to a thread and performs a read of a shared resource, this resource can no longer be modified during the execution of the read instructions between two synchronization points. In practice, the future execution of the sequences of instructions assigned to the threads is done randomly. Consequently, it will be possible to have a write operation before a read operation, thus modifying the expected value. Moreover, in the context of the execution of the test sequences, no provision is made for anticipating the order in which these sequences are executed. Consequently, arbitration for access contention to shared resources is applied by the introduction of the synchronization points and the execution of the instructions between these points, as described previously.

Referring to FIG. 3, it will be noted that the test generator may use memory address areas previously initialized by the same computation thread.

It should also be noted that the sequences of test instructions are performed alternately from one synchronization point to another, until an output point S where an output sequence written for each computation thread performs a test to check the memory and the registers.

However, each computation thread checks its own registers used during the test. However, only one of the computation threads checks the memory since, during the test procedure, the memory is shared for all the sequences of test instructions.

It should also be noted that, for example, a method for testing a multitasking computation architecture may be produced by means of the following instruction codes:

```
“ST_TEST_TEMPLATE:
        DATA_SEQUENCE:num_instr=″5″
INSTRUCTIONS_SEQUENCES{
  CODE_THREAD_0{
        INIT_SEQUENCE{num_instr=[10..10]};
INIT_IF;
  SEQ_ARITH{num_instr=[5..10]};
      ELSE;
        SEQ_LD_ST{num_instr=[5..10]};
        INIT_FOR{num_iter=[10..100]};
        SEQ_ARITH{num_instr=[5..5]};
        END_FOR;
  END_IF;
  SYNCHRO;
  INIT_FOR{num_iter=[10..100]};
        SEQ_ARITH{num_instr=[5..5]};
        INIT_FOR{num_iter=[10..100]};
              SEQ_ARITH{num_instr=[5..5]};
        END_FOR;
END_FOR;
SYNCHRO;
SEQ_LD_ST{num_instr=[5..10]};
EXIT;
};
CODE THREAD_1{
              INIT_SEQUENCE{num_instr=[10..10]};
              SEQ_ARITH{num_instr=[5..10]};
              SYNCHRO
              SEQ_LD_ST{num_instr=[5..10]};
              SYNCHRO
              SEQ_LD_ST{num_instr=[5..10]};
              EXIT;
              };
CODE_THREAD_2{
            INIT_SEQUENCE{num_instr=[10..10]};
            SEQ_LD_ST{num_instr=[5..10]};
            SYNCHRO
            SEQ_ARITH{num_instr=[5..10]};
            SYNCHRO
            SEQ_LD_ST{num_instr=[5..10]};
            EXIT;
            };
CODE_THREAD_3{
            INIT_SEQUENCE{num_instr=[10..10]};
            SEQ_LD_ST{num_instr=[5..10]};
            SYNCHRO
            SEQ_ARITH{num_instr=[5..10]};
            SYNCHRO
            SEQ_ARITH{num_instr=[15..15]};
            EXIT;
            };
  };”
```

While this detailed description has set forth some embodiments of the present invention, the appended claims cover other embodiments of the present invention which differ from the described embodiments according to various modifications and improvements.

Within the appended claims, unless the specific term “means for” or “step for” is used within a given claim, it is not intended that the claim be interpreted under 35 U.S.C. 112, paragraph 6.

What is claimed is:

1. A device comprising:
a test generator generating sequences of test instructions corresponding to programming rules for the computation architecture; and
a controller coupled to the test generator, the controller controlling a parallel execution of the sequences of test instructions so that said sequences of test instructions are alternately executed.

2. The device according to claim 1, wherein the controller synchronizes the alternate execution of the sequence of test instructions.

3. The device according to claim 1, further comprising architecture data representative of the computation architecture to be tested.

4. The device according to claim 1, wherein the test generator incorporates a description of the programming instructions for the computation architecture.

5. A method for testing a multitasking computation architecture, the method comprising:
generating sequences of test instructions corresponding to programming rules for the multitasking computation architecture; and
executing the sequences of test instructions so that said sequences of test instructions are alternately executed.

6. The method according to claim 5, wherein the executing the sequences of test instructions is performed in steps between two successive synchronization points up to an output point, each step comprising:
executing a first sequence of instructions until a first synchronization point is reached; and
successively executing consecutive sequences of instructions, each sequence of instructions being executed until said first synchronization point is reached for said sequence.

7. The method according to claim 6, wherein a number of identical synchronization points is provided for each sequence of test instructions.

8. The method according to claim 5, wherein the sequences of test instructions are chosen randomly.

9. A computer program product for testing a multitasking computation architecture, the computer program product having a computer-readable, non-transitory medium with a computer program embodied thereon, the computer program comprising:
computer program code for generating one or more test programs for each of a plurality of threads executed at least in part in parallel to one another, wherein the computer program code for generating includes computer program code for synchronizing the test programs of the plurality of threads; and
computer program code for controlling parallel execution of the one or more test programs.

10. The computer program product according to claim 9, wherein the plurality of threads is performed by a plurality of processors.

11. The computer program product according to claim 9, wherein the computer program code for synchronizing includes waiting points.

12. The computer program product according to claim 11, wherein a number of waiting points is identical for all of the plurality of threads.

13. The computer program product according to claim 9, wherein the computer program code for controlling includes computer program code for executing a first test program until a waiting point is reached.

14. The computer program product according to claim 13, wherein the computer program code for executing includes computer program code for executing test programs for each respective thread until the waiting point is reached by each thread.
